(19) United States
(12) Patent Application Publication
(10) Pub. No.: US 2008/0078098 A1
(43) Pub. Date: Apr. 3, 2008

(54) Device for removing water from a work

(75) Inventor: Kaoru Ichihashi, Higashiomi-Shi (JP)

Correspondence Address: VENABLE LLP, P.O. BOX 34385, WASHINGTON, DC, 20043-9998, US

(73) Assignee: Shigayamashita Co., Ltd., Higashiomi-Shi (JP)

(21) Appl. No.: 11/902,872

(22) Filed: Sep. 26, 2007

(30) Foreign Application Priority Data
Oct. 2, 2006 (JP) 2006-270843

(51) Int. Cl. F26B 25/08

(52) U.S. Cl. 34/239

(57) ABSTRACT

[Problem (Object)] The problem (object) is to provide a device for removing water from a machined piece (work) which realizes a technique for completely (sufficiently) removing water beads deposited on a work.

[Means to Solve the Problem (Means to Attain the Object)] The water removing device comprises an air blowing box 2 for holding a work 1 to be subjected to water removal; a work clamping jig 3 mounted in the air blowing box 2 for clamping the work 1; a jig rotating mechanism 4 for rotating the work clamping jig 3 to rotate the clamped work 1, thereby causing water beads deposited on the work 1 to drop; and an air blower 5 for generating an air current flowing in the same direction as the a falling direction of water drops 11 which have been caused to drop from the work 1.

### TECHNICAL FIELD

The present invention relates to a device for removing water from a work which is capable of completely or sufficiently removing, after washing a machined product (work) molded by casting such as an auto part or the like and draining water from the work, residual water beads deposited on the work.

### BACKGROUND ART

Many of various machine parts such as auto parts are machined by machine tools and then subjected to washing with water in order to remove deposited matter.

As a technique for removing water from a washed work, there has heretofore been employed a technique which removes residual liquid on a surface or in a hole or cavity of the work by blowing compressed air against the work by means of an air blower.

In this air blowing mode, however, blown fine water beads are likely to re-deposit on the work. Otherwise, only water in areas in the surface of the work which are directly exposed to the air blow is blown away therefrom. However, the water is not necessarily removed but is likely to remain on the periphery of the work.

Further, blowing of compressed air requires a great deal of energy, and water removing effect is insufficient for the high operation cost.

### [Patent Document 1] Null

### DISCLOSURE OF INVENTION

### Problem to be Solved by the Invention

The problem to be solved by the present invention is to provide a device for removing water from a work which is capable of completely or sufficiently removing residual water beads remaining on a surface or in a hole or cavity or the like of the work and which is capable of overcoming the drawbacks inherent in the conventional known technique.

### Means to Solve the Problem

To solve the above-described problem, a device for removing water from a work according to the present invention characteristically comprises:

an air blowing box for holding a work to be subjected to water removal;

a work clamping jig mounted in the air blowing box for clamping the work;

a jig rotating mechanism for rotating the work clamping jig to rotate the clamped work, thereby causing water beads deposited on the work to drop; and

an air blower for generating an air current flowing in the same direction as a falling direction of water drops which have been caused to drop from the work.

### EFFECT OF THE INVENTION

According to the present invention, the water removing device A comprises an air blowing box for holding a work to be subjected to water removal; a work clamping jig mounted in the air blowing box for clamping the work; a jig rotating mechanism for rotating the work clamping jig to rotate the clamped work, thereby causing water beads deposited on the work to drop; and an air blower for generating an air current flowing in the same direction as the a falling direction of water drops which have been caused to drop from the work. By virtue of this, residual liquid remaining on a surface or in a hole or cavity of the work is completely or sufficiently removed, and no re-deposition of the residual liquid, which has bee blown off, on the surface of the work is caused.

### BEST MODE FOR CARRYING OUT THE INVENTION

In the following, the present invention will be described in detail with reference to the accompanying drawings.

FIG. 1 is a side view of an embodiment of the present invention and FIG. 2 is a plan view of the same.

The present invention is a water removing device A which is capable of completely (sufficiently?) removing residual washing liquid remaining on a surface or in a hole or the like of a machined product (work) 1, and the water removing device comprises an air blowing box 2 for holding a work 1 to be subjected to water removal, a work clamping jig 3, a jig rotating mechanism 4, and an air blower 5, as shown in FIG. 1 which is the side view of the water removing device A. FIG. 2 is the plan view of the water removing device A.

In the air blowing box 2, the work 1 is placed by means of transfer equipment (not shown), and the work 1 is clamped, and then a work entrance is closed with a shutter. The shutter is provided with an opening for air introduction.

The work 1 clamped by the clamping jig 3 is rotated by the jig rotating mechanism 4 to effect removal of water from the work 1. In the jig rotating mechanism 4, a servo motor 9 is numerically controlled (NC controlled). The clamping jig 3 is thereby rotated in the optimum posture. Reference number 10 represents a reduction gear.

In concurrence (In parallel) therewith, the air blower 5 is operated to introduce air into the air blowing box 2 from the top portion of the air blowing box 2. The introduced air makes an air current flowing in the same direction as a falling direction of water drops which have been caused to drop from the work 1. The air blower 5 comprises an exhaust blow fan 12, and by operating this, the air current 6 passes from the top portion of the air blowing box 2 through the air blowing box 2 to sweep balong the work 1, thereby causing water drops 11 to fall downward.

The work 1 is rotated in the direction of the arrow about a rotating center shaft 8 of the clamping jig 3, and water beads on the work 1 are caused to fall as falling water drops 7. Reference number 13 represents an exhaust air.

In this manner, the water drops which have been caused to drop from the work 1 fall along the air current 6, and no re-deposition of the water drops on the surface of the work 1 is caused.

### INDUSTRIAL APPLICABILITY

As described above, according to the water removing device A of the present invention, water drops fall along the air current 6 and no re-deposition of the water drops on the surface of the work 1 is caused. Therefore, the water removing device has high usefulness (utility) in the field of washing technology.

### BRIEF DESCRIPTION OF DRAWINGS

FIG. 1 is a side view of an embodiment of the device for removing water from a work.

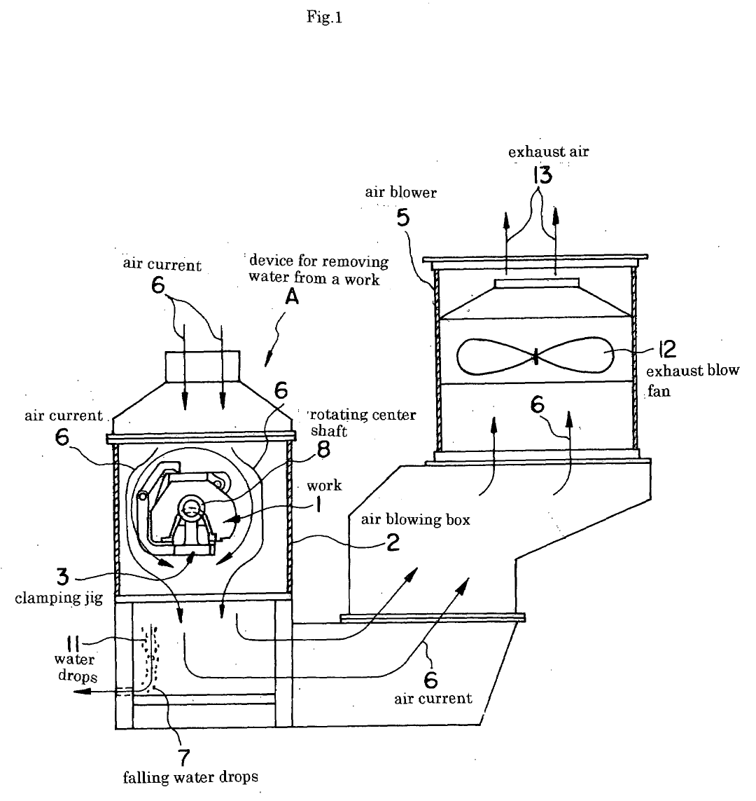

FIG. 2 is a plan view of the water removing device A shown in FIG. 1.

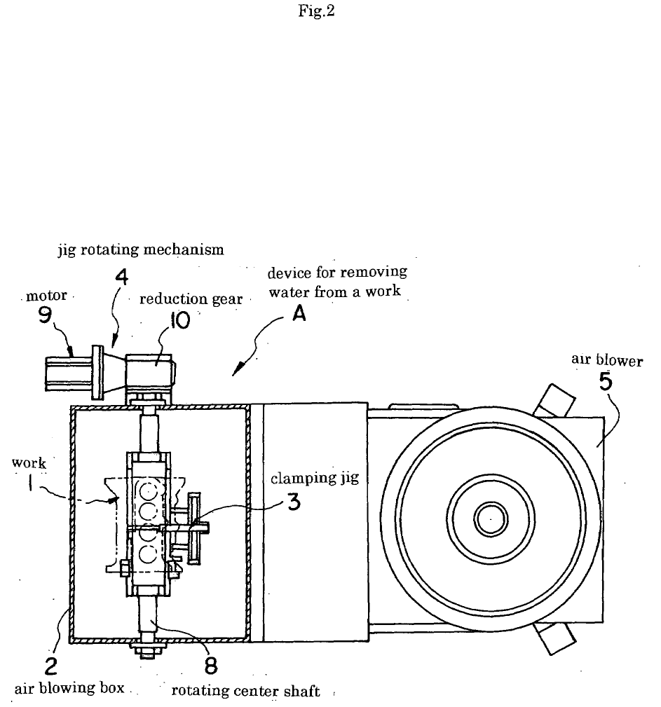

### NOTE ON REFERENCE NUMBERS

A: device for removing water from a work
1: work
2: air blowing box
3: clamping jig
4: jig rotating mechanism
5: air blower
6: air current
7: falling water drops
8: rotating center shaft
9: motor
10: reduction gear
11: water drops
12: exhaust blow fan
13: exhaust air

1. A device for removing water from a work which is capable of sufficiently removing water beads deposited on the work, said device comprising:
an air blowing box for holding a work to be subjected to water removal;
a work clamping jig mounted in the air blowing box for clamping the work;
a jig rotating mechanism for rotating the work clamping jig to rotate the clamped work, thereby causing water beads deposited on the work to drop; and
an air blower for generating an air current flowing in the same direction as a falling direction of water drops which have been caused to drop from the work.

2. The device for removing water from a work according to claim 1, wherein the air blower is an exhaust blow fan disposed downstream from the air blowing box.

3. The device for removing water from a work according to claim 1, wherein a compressed air blowing nozzle is used in combination therewith.

4. The device for removing water from a work according to claim 1, wherein a servo motor is used for the rotational operation of the jig to thereby enable the jig to perform the removal of water in the optimum posture.
